(19) United States
(12) Patent Application Publication
(10) Pub. No.: US 2002/0087860 A1
(43) Pub. Date: Jul. 4, 2002

(54) Cryptographic data security system and method

(76) Inventor: David William Kravitz, Fairfax, VA (US)

Correspondence Address: BAKER & BOTTS, 30 ROCKEFELLER PLAZA, NEW YORK, NY, 10112

(21) Appl. No.: 10/010,995

(22) Filed: Oct. 19, 2001

Related U.S. Application Data
(60) Provisional application No. 60/242,083, filed on Oct. 20, 2000.
(60) Provisional application No. 60/246,843, filed on Nov. 8, 2000.

(51) Int. Cl. H04L 9/00

(52) U.S. Cl. 713/168

(57) ABSTRACT

A method for communicating between a computer device and a trusted server is disclosed. According to the method of the invention, a one-time password for use in communication from the device to the server is generated. The device generates at least one one-time request-authentication datum that includes a function of at least a portion of a previous response from the server to a previous message from the device. The server then generates at least one one-time response authentication datum that includes a function of at least a portion of at least one one-time password.

The present invention relates to improving security in data communications systems and in particular to systems and methods for providing confidentiality, trust, and attack-resistance for data that may be transmitted over insecure or dubiously-secure networks, such as the Internet.

Data communications, specifically communications between a plurality of computer users over a distributed data network, for instance, are known to be subject to multiple varieties of attacks by persons (henceforth referred to as “insiders” or “interceptors”) not authorized by the communication parties or intended data recipients. Such attacks may be motivated by a desire to view private information, to commit financial or other fraud, or simply to corrupt communications integrity for whatever reason.

The use of the term “one-time” in the specification and claims is intended to reflect an enabled capability to specify a means and accommodate the results of dynamic update or replacement of certain passwords and datums. The degree of acceptable reuse of such “one-time” values from the perspective of a device or server is determined by the particular implementation and is not prescribed herein.

In the context of a network including a server computer and one or more client computers having access to data from said server (as, for instance, in a World Wide Web-based webserver context), a connection depletion attack, as defined in Juels, A. and Brainard, J., Client Puzzles: A Cryptographic Countermeasure against Connection Depletion Attacks, http://www.rsasecurity.com/rsalabs/staff/ajuels, 1999, first presented at the Network and Distributed System Security Symposium, San Diego, Calif., Feb. 3, 1999 (hereinafter “Juels and Brainard”) (herein incorporated by reference) is one in which the attacker seeks to initiate and leave unresolved a large number of connection (or service) requests to a server, exhausting its resources and rendering it incapable of servicing legitimate requests.

A variety of attempts have been made in the art to increase resistance to connection depletion attacks.

Juels and Brainard addresses this type of denial-of-service problem without distinguishing between classes of clients. Juels and Brainard uses cryptographic “puzzles” which are dynamically changed to discourage an outsider break-in.

Another approach, published at http://www.rsasecurity.com/products/securid/datasheets/dsauthenticators.html (hereinafter “Dsauthenticators”), uses SecurID authenticators. These are hardware or software tokens each providing a sequence of one-time passwords based on a token-unique key applied successively in the context of a proprietary algorithm. The client-side host transmits the current onetime password and a constant PIN or passphrase to a server to which it wants to identify itself. A server that possesses knowledge of the token-unique keys can synchronize with the client tokens, and thereby recognize the (remote) presence of the particular client upon receipt of the one-time password and PIN. This is a self-synchronizing system, in which the client token does not adjust its behavior based on inputs from the server on a per-transaction basis. Furthermore, the system is designed to provide entity authentication, but not authentication of the origin or integrity or the “freshness” of any ensuing communications.

The method described in Rivest, R., Shamir, A., and Adleman, L., A Method for Obtaining Digital Signatures and Public-Key Cryptosystems, Communications of the A.C.M. 1978, 21, 120-26 (hereinafter “Rivest, Shamir and Adleman”) (and enhanced based on Bellare, M., and Rogaway, P., Optimal Asymmetric Encryption—How to Encrypt with RSA, Nov. 19, 1995 (revised version of Optimal Asymmetric Encryption Padding paper: http://wwwcse.ucsd.edu/users/mihir/papers/oaep.html; earlier version published in Advances in Cryptology—Eurocrypt 94, Lectures in Computer Science, A. DeSantis Ed., Springer Verlag, 1994, 950, 92-111 (hereinafter “Bellare and Rogaway”) as explained further in Johnson, D. B., and Matyas, S. M., Asymmetric Encryption: Evolution and Enhancements, Cryptobytes, Spring 1996, Volume 2, No. 1 (see also http://www.rsalabs.com/cryptobytes) (hereinafter “Johnson and Matyas”) provides a means for two parties to secure the confidentiality of their communications, where the transmitting party employs the public key of the receiving party for the purpose of encryption and the receiving party employs its corresponding private key for the purpose of decryption (recovery of plaintext). The method is asymmetric in that the two parties use keys that are distinct from each other, although they are algorithmically related or paired. The method in Rivest, Shamir and Adleman can also be used to instantiate a digital signature capability, where the signing party applies its private key to the message to be signed in accordance with the method, and the verifying party applies the corresponding public key in accordance with the method in order to verify the authenticity of the origin and the integrity of the message. Digital signatures, in and of themselves, do not provide evidence of freshness; i.e., a previously used message may be replayed without being detected as a “stale” message.

Two parties can communicate using a symmetric-key encryption algorithm, such as DES. In this case, the same key is known to both parties. DES can also be used to provide a message authentication code (MAC) capability. Thus, a receiving party which possesses knowledge of the secret key can determine that the originator of the message also had knowledge of the secret key and that the message has not been altered in transit.

Messages or portions thereof can be encrypted to conceal the identity of the client from parties other than the server, and to make it more difficult to link transactions as having come from the same client. In this case, the server needs to apply the decryption algorithm before performing any processing which requires knowledge of the party's identity. If digital signatures are applied to messages, an adversary can use the list of public keys to group the communications transactions according to the signers, since messages verified using the incorrect public key should fail verification. If the signatures are encrypted, or the signature is computed over the plaintext message where the message is transmitted in encrypted form, then verification of the signature requires preliminary decryption.

Thus, there is a need for a secure communications method that does not require signature verification. There is also a need for a secure method that is not self-synchronizing, so that the server is not required to possess knowledge of token-unique keys as well as self-regulated input to the one-time password update algorithm, such as time or counters in order to synchronize with the client tokens. There is also a need for a method that does not abridge privacy by enabling unauthorized access to client-identifying information. Finally, there is a need for a secure method that takes advantage of registered client devices that can transmit patterns according to a protocol, where the server can differentiate such patterns from other incoming Internet traffic. The prior art is not believed to meet these needs.

### SUMMARY OF THE INVENTION

The present invention is directed to a method for communicating between a computer device and a trusted server. The method includes the steps of: (a) generating a one-time password for use in communication from the device to the server; (b) generating at least one one-time request-authentication datum that includes a function of at least a portion of a previous response from the server to a previous request from the device; and (c) generating at least one one-time response-authentication datum that includes a function of at least a portion of at least one onetime password. Preferably, the one-time request-authentication datum or the one-time response-authentication datum or both comprise a function of an encryption key. At the point at which a one-time password is “used” in a communication from a device to a server as associated with a request, the one-time password may be exposed to interception, while the dependence of a response-authentication datum on a one-time password is with respect to a one-time password that has not yet been so used. Thus the transmission of a response message may be considered part of the (secure) negotiation or exchange of a one-time password which precedes its actual use during a later request. The encrypted transmission of a one-time password or a component thereof within a request message for the purpose of conveying knowledge of this information to a server equipped with the capability to execute the corresponding decryption is not considered use of the one-time password. Interception of a response from a server to a device does not enable successful generation or verification of a one-time request-authentication datum. Interception of a request from a device to a server does not enable successful generation or verification of a one-time response-authentication datum.

Another object of the invention is to provide a method for transmitting a data request from a client device, comprising: (a) generating a one-time password; and (b) generating at least one one-time request-authentication datum comprising a function of at least a portion of a previous response from a trusted server to a previous request from the device. Preferably, the one-time request-authentication datum comprises a function of an encryption key.

Another object of the invention is to provide a method for transmitting a response from a trusted server to a request from a client device, comprising: (a) receiving a request comprising a function of at least a portion of at least one one-time password shared between the device and said server; and (b) generating at least one one-time response-authentication datum comprising a function of at least a portion of at least one one-time password. Preferably, the one-time response-authentication datum comprises a function of an encryption key.

Another object of the invention is to provide a system for enhancing trust in communications between a client device and a trusted server, comprising: (a) means for establishing a network connection between the client device and the server; and (b) means for conducting communications of data with the client device over the network connection, wherein the communications between the device and the server are conducted in accordance with a method comprising: (i) generating a one-time password for use in communication from the device to the server; (ii) generating at least one one-time request-authentication datum comprising a function of at least a portion of a previous response from the server to a previous request from the device; and (iii) generating at least one one-time response-authentication datum comprising a function of at least a portion of at least one one-time password. Preferably, the system further comprises an encryption algorithm and means for downloading the encryption algorithm to the client computer over the network connection, wherein the means for conducting communications of data with the client computer over the network connection is in accordance with the encryption algorithm and wherein the communications between the device and the server are conducted on an encrypted basis.

Another object of the invention is to provide a system for enhancing trust in communicating a data request from a client device, comprising: (a) means for establishing a network connection between the client device and a trusted server; and (b) means for conducting communications of data with the client device over the network connection, wherein the communications between the device and the server are conducted in accordance with a method comprising: (i) generating a one-time password; and (ii) generating at least one one-time request-authentication datum comprising a function of at least a portion of a previous response from a trusted server to a previous request from the device. Preferably, the system further comprises an encryption algorithm and means for downloading the encryption algorithm to the client computer over the network connection, wherein the means for conducting communications of data with the client computer over the network connection is in accordance with the encryption algorithm and wherein the communications between the device and the server are conducted on an encrypted basis.

Another object of the invention is to provide a system for enhancing trust in communicating a response from a request from a client device to a trusted server, comprising: (a) means for establishing a network connection between the client device and the server; and (b) means for conducting communications of data with the client device over the network connection, wherein the communications between the device and the server are conducted in accordance with a method comprising: (i) receiving a request comprising a function of at least a portion of at least one one-time password shared between the device and the server; and (ii) generating at least one one-time response-authentication datum comprising a function of at least a portion of at least one one-time password. Preferably, the system comprises an encryption algorithm and means for downloading the encryption algorithm to the client computer over the network connection, wherein the means for conducting communications of data with the client computer over the network connection is in accordance with the encryption algorithm and wherein the communications between the device and the server are conducted on an encrypted basis.

The present invention is also directed to a method for resynchronizing the communication between a client device and a trusted server, which includes the steps of: (a) generating or retrieving a one-time password for use in communication from the device to the server; (b) generating or retrieving at least one one-time request-authentication datum that includes a function of at least a portion of a previous response from the server to a previous request from the device; and (c) generating or retrieving at least one one-time response-authentication datum that includes a function of at least a portion of at least one one-time password. In one preferred embodiment, the one-time request-authentication datum comprises an All NULLs message encryption key. In another preferred embodiment, the one-time response-authentication datum comprises an All NULLs message encryption key. The method may be configured so that a request received by the server that uses a one-time password that is not recognized as current by the server may result in the transmission of a previously generated response if any at all. A resynchronization request message is considered to be (one type of) a request message. A resynchronization response message is considered to be (one type of) a response message.

Another object of the invention is to provide a method for transmitting a resynchronization request from a client device, comprising: (a) generating or retrieving a one-time password; and (b) generating or retrieving at least one one-time request authentication datum comprising a function of at least a portion of a previous response from a trusted server to a request from the device. In a preferred embodiment, the one-time request-authentication datum comprises an All NULLs message encryption key. In another preferred embodiment, the resynchronization request comprises an encrypted resynchronization datum that replaces a previous resynchronization datum.

Another object of the invention is to provide a method to transmit a resynchronization response from a trusted server, comprising: (a) receiving a request comprising a function of at least a portion of at least one one-time password associated with a client device; and (b) generating or retrieving at least one one-time response-authentication datum comprising a function of at least a portion of at least one one-time password. In a preferred embodiment, the one-time response-authentication datum comprises an All NULLs message encryption key. In another preferred embodiment, the resynchronization response comprises an encrypted resynchronization datum that replaces a previous resynchronization datum.

Another object of the invention is to provide a system for resynchronizing communication between a client device and a trusted server, comprising: (a) means for establishing a network connection between the client device and the server; and (b) means for conducting communications of data with the client device over the network connection, wherein the communications between the device and the server are conducted in accordance with a method comprising: (i) supplying a one-time password for use in communication from the device to the server; (ii) supplying at least one one-time request-authentication datum comprising a function of at least a portion of a previous response from the server to a previous request from the device; and (iii) supplying at least one one-time response-authentication datum comprising a function of at least a portion of at least one one-time password. Preferably, the system comprises an encryption algorithm and means for downloading the encryption algorithm to the client computer over the network connection, wherein the means for conducting communications of data with the client computer over the network connection is in accordance with the encryption algorithm and wherein the communications between the device and the server are conducted on an encrypted basis.

Another object of the invention is to provide a system for enhancing trust in transmission of a resynchronization request from a client device, comprising: (a) means for establishing a network connection between the client device and a trusted server; and (b) means for conducting communications of data with the client device over the network connection, wherein the communications between the device and the server are conducted in accordance with a method comprising: (i) supplying a one-time password; and (ii) supplying at least one one-time request authentication datum comprising a function of at least a portion of a previous response from the server to a request from the device. Preferably, the system comprises an encryption algorithm and means for downloading the encryption algorithm to the client computer over the network connection, wherein the means for conducting communications of data with the client computer over the network connection is in accordance with the encryption algorithm and wherein the communications between the device and the server are conducted on an encrypted basis.

Another object of the invention is to provide a system for enhancing trust in transmission of a resynchronization response from a trusted server, comprising: (a) means for establishing a network connection between a client device and the server; and (b) means for conducting communications of data with the client device over the network connection, wherein the communications between the device and the server are conducted in accordance with a method comprising: (i) receiving a request comprising a one-time password associated with a client device; and (ii) supplying at least one one-time response-authentication datum comprising a function of at least a portion of at least one one-time password. Preferably, the system of claim 34, further comprising an encryption algorithm and means for downloading the encryption algorithm to the client computer over the network connection, wherein the means for conducting communications of data with the client computer over the network connection is in accordance with the encryption algorithm and wherein the communications between the device and the server are conducted on an encrypted basis.

The present invention uses a tightly integrated approach in order to provide simultaneous coverage of various aspects of efficient client—trusted server bi-directional communications security. Unlike Juels and Brainard, the present invention takes advantage of the fact that registered client devices form a distinguished class of clients which can transmit patterns according to a protocol which can be differentiated from other incoming Internet traffic by the server. The invention uses the method in Rivest, Shamir and Adleman (as enhanced based on Bellare and Rogaway) in order to securely transmit components of one-time passwords and of one-time-use MAC keys that are used in subsequent messages for bi-directional message origin, integrity, and freshness, as well as unlinkability of client messages, in association with the use of encryption and MACs (in accordance with FIPS 46-3 Data Encryption Standard and FIPS 81 DES Modes of Operation (MACing), published at http://csrc.nist.gov/cryptval/des.htm (hereinafter “FIPS”)). Consequently, unlike DSauthenticators, the method is not self-synchronizing; resynchronization is handled efficiently on the server end by retransmission. The server does not need to track or distinguish between legitimate and fraudulent requests which are communicated using previously (versus currently) valid one-time passwords, because no (potentially resource-intensive) cryptographic processing is done by the server in such cases; a retrieval and (re-)transmission of a previously generated response may be done, without the need for further computation or database-updating.

Message processing on the server end is handled by a denial-of-service resistant phased approach, which first dispels request messages (as candidates for further new processing) that are not accompanied by a currently legitimate one-time password. The inclusion of a currently legitimate one-time password results in a “hit” on the server database, in which case the one-time password is used for database lookup of information pertaining to a single client device. If the one-time-use MAC key in that database entry when applied to the appropriate data fields of the request message indicates message compliance, RSA decryption is done using the server's private key (which can be secured within a crypto module or hardware security module (HSM) at the server). RSA decryption uncovers information pertaining to the next one-time password and the message key (if present) which is used to decrypt that portion of the request message, if any, which was transmitted using a bulk encryption algorithm (such as a variant of DES). The server computes a response message, that incorporates a message authentication code (MAC) computed using a current MAC key derived, at least in part, by using knowledge of the next one-time password or a component thereof that was transported within the most recently received request message. The response message may also convey a freshly generated message key and a component of the next one-time-use MAC key for the client's next request. The means of conveyance may be encryption under the client's public key as pointed to in the server database. The response message may also include bulk-encrypted data, where the corresponding plaintext can be recovered using the (response-)message key. The (encryption-capable) device of the present invention refers to the client device, and not the server or a hardware security module (HSM) at the server.

The public/private key pairs of both the device and the device server (i.e., trusted server) are used to update the shared secrets necessary to negotiate secure communications on a transactional basis. This offers several advantages over the standard techniques of signing encrypted communications or encrypting signed communications with respect to privacy, computational overhead, and denial-of-service attacks. A purely symmetric key approach would lead to the possibility of attack based on a static snapshot of values in the device server database. If a device loses cryptosynchronization with the device server because of an incomplete transaction, synch is reestablished without providing privacy-threatening linkage between the aborted and subsequent transactions and without having the device accept outdated or unwanted information. Given the list of device public keys, one cannot partition transactions according to which devices were involved.

The use of Optimal Asymmetric Encryption Padding (OAEP) along with RSA thwarts attempts to link transactions by encrypting data which is revealed during the protocol and trying to match the ciphertext to previous transactions. Request- and Response-message keys are independently generated so that obtaining a snapshot of the device server database would not afford one the opportunity to put forth a Request message with an emulated device which results in a Response message encrypted in the known message key used within the Request. With respect to denial-of-service, the system takes advantage of the fact that registered devices form a distinguished class in that their output can be differentiated at the server from other incoming Internet traffic. If the use of the one-time password within the incoming request message results in a fresh (or current) hit in the device server database, the server uses the “hit” device entry to check the MAC, followed by the RSA decryption to recover the message key, and symmetric algorithm decryption with the message key to recover the plaintext. If the use of the one-time password within the incoming request message refers to the transaction that the device server has just-previously processed, the server retransmits the previous response without incurring additional processing or database updates. The secure communications protocol is designed so that if critical operations are executed within a secure-crypto- (or hardware-security-) module at the device server, unauthorized database access would not in itself undermine the integrity of the system.

The secure communications protocol described below does not require the use of public-key cryptography for the purpose of digital signatures, but rather only for encryption (and decryption). From an efficiency point of view, it is important to note that as successful verification of secure communications serves as an indication of a properly registered functioning device, any digital signatures which are generated and transmitted by the device within the “plaintext” can be archived and later verified out-of-band, offline from the transaction processing. The plaintext is encrypted under the message key, where the encrypted message key and encrypted plaintext are authenticated by a MAC under secure communications. Provided that any included signatures are full signatures, in that they are accompanied by the text that is signed, the secure communications protocol serves to authenticate the text independently of the non-repudiation capability enabled by the inclusion of signatures.

A properly functioning device would not accept bogus signatures within secure communications requests, because the generation and handling of these signatures would be controlled by the device. Consequently, the method of the present invention may be implemented so as not to require verification, by the server, of signatures at the same time as the message. A signature can be treated as a “blob” in that it can be stored and verified afterwards. To handle real-time authentication, client generation and server verification of a message authentication code (MAC) is employed instead. For this purpose, a symmetric key is used. The method of the present invention may further comprise a procedure to establish the freshness of the message, that is, whether the message has been previously used or intercepted prior to current receipt.

One advantage of the method of the present invention is that a message cannot be linked to a client. Thus, for example, if a message is intercepted, the present method does not enable the interceptor to tell where the message came from.

The method of the present invention is not self-synchronizing. Thus, the proper functioning of the method does not require that the client device periodically adjust its behavior based on server input so that the device and server can independently maintain synch between such realignments. Instead, synchronization is recovered on a transactional basis through retransmission from, or synchronization message processing by, the server.

Accordingly, the present invention includes a secure communications method that does not require signature verification. It further provides a secure method that is not self-synchronizing. Finally, since the client devices are registered with the trusted server, they form a distinguished class of devices that transmit patterns, according to a protocol, that can be differentiated from other incoming Internet traffic by the server.

### BRIEF DESCRIPTION OF THE FIGURES

FIG. 1 shows a flow chart of the sequence of operations the client device performs to transmit a request to the trusted server.

FIG. 2 shows a flow chart of the sequence of operations the client device performs to transmit a resynchronization request to the trusted server.

FIG. 3 shows the sequence of operations the trusted server performs to transmit a response to a request from the client device.

FIG. 4 shows the sequence of operations the trusted server performs to transmit a resynchronization response to a resynchronization request from the client device.

### DETAILED DESCRIPTION OF THE PREFERRED EMBODIMENTS OF THE Invention

The following is a discussion of several particularly useful embodiments of the present invention. The trusted server according to the present invention preferably comprises two components. The first component is a host processor and database capable of tracking state changes. The second component is a hardware security module (HSM) equipped with cryptographic processing capability and secured storage of fixed values.

The client device according to the present invention likewise preferably comprises two components. The first component is a processor. The second component is a co-processor in a secure environment. Data may be encrypted by the co-processor of the client device and intended for the HSM of the trusted server. Thus, the encrypted data can only be decrypted by the HSM, and not, for example, by an insider at the trusted server. The HSM of the trusted server and the co-processor of the client device each have a private key. In addition, the public key for each particular client device is recognized by the HSM. The public-private key pair for each device may be defined at the production or registration stage.

The HSM also makes the decision whether the decrypted data is released for storage into a database on the trusted server. When a next message is prepared by the HSM for transmission to a client device, the HSM needs to access the database on the trusted server for data specific to that particular client device. The device will not accept the message as valid unless the HSM has demonstrated knowledge of data that is device-specific and current. The same holds true for a message sent by the client device to the trusted server—the HSM will not accept the message for response processing unless it can access data in the trusted server database for that client device that accurately corresponds to the received message. The HSM will not accept the message unless the creator of the message had current access to the device or the corresponding database entry.

The method of the invention uses a one-time password that is incorporated into the request message sent from the client device to the trusted server. The onetime password in the request-authentication datum may be used by the server to locate an entry in its database that corresponds to the client device. While the “current” one-time password is thus included, this authenticated request message and the resulting and confirming response message from the server include an exchange of data which sets the “next” one-time password at both the device and the server, without exposing or disclosing its value. Preferably, the request-authentication datum comprises an encrypted secret datum, wherein the server decrypts the encrypted secret datum to recover the secret datum. Preferably, a next or later request comprises a function of at least a portion of at least one one-time password comprising at least a portion of at least one secret datum. The private exchange of data ensures that even if an insider gets a “snapshot” of the trusted server database, he would be unable to use this acquired knowledge alone in order to deceive the HSM into thinking that he is the client once the actual client has caused an update of the database by successfully transacting with the trusted server. Furthermore, an insider cannot interpret a response from the HSM, even if he has submitted the request based on current database access, because he lacks the device private key and because the message key used to encrypt plaintext within the response is not derivable based solely on knowledge of the message key in the request. An insider also cannot interpret an incoming message from the client, because he lacks the HSM private key.

In a preferred embodiment, the protocol used is defined as follows:

Terminology and Notation

{x}EntityPubK represent RSA-OAEP (optimal asymmetric encryption padding) encryption of a message x under the RSA public key of Entity.

{PT}MsgK represents the symmetric-algorithm (e.g., triple-DES) encryption of (plaintext) PT under message key MsgK.

MAC(data)Key represents the symmetric-algorithm based MAC of data under the key Key.

Protocol Header comprises cleartext data (i.e., data transmitted unencrypted), which may include items pertaining to protocol version or other data that is useful to receive prior to further processing and not sensitive to disclosure. The Protocol Header data field, if not of fixed length, may include a fixed length preamble which specifies its length.

The use of a comma (“,”) between arguments or data fields indicates concatenation. [a,b] indicates the concatenation of a followed by b.

“.XOR.” denotes bit-wise exclusive-or, i.e., component-wise addition modulo-2 of like-length vectors. MAC(data)K₁.XOR.K₂ is the MAC value that results from operating over “data” using K₁.XOR.K₂ as the key.

H(m) indicates the result of applying a one-way hash function (e.g., SHA-1) to a message m.

Device-Side Basic Flow

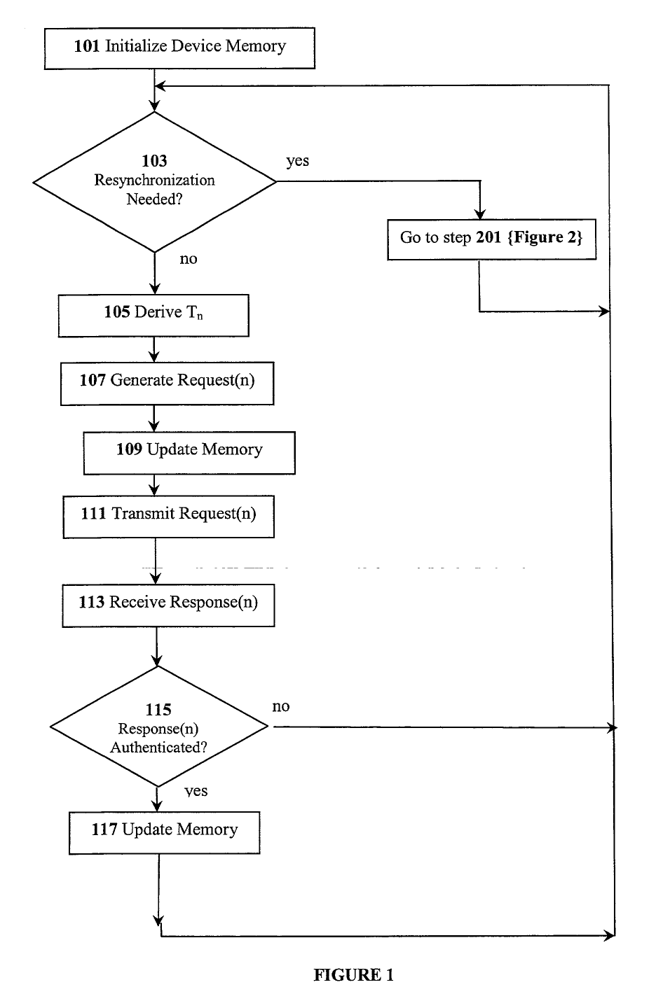

Suppose that at the conclusion of successful registration of the client device (in accordance with known methods), the device and the trusted server share two secret values denoted by T₀ and T_{0TS}, and each maintains a reliable copy of the other's public key. For this embodiment, the generation of T₀ and T_{0TS} may be such that T_{0TS}.XOR. T₀ is a (2-key triple-DES) key. Reference is now made to FIG. 1. In general, if the device and the trusted server are in (crypto-)synchronization, the persistent memory of the device prior to beginning the process of Request(n) is:

Tₙ₋₁, T_{n-1TS}, Blank,

where Tₙ₋₁ is a one-time password.

If resynchronization with the trusted server is needed (103) as evidenced by a value other than “Blank” in that data position, the device generates a resynchronization request as further discussed below. If resynchronization is not needed, when the device wants to initiate Request(n), it derives (105) a new 2-key triple-DES key X, and lets Tₙ=X .XOR. T_{n-1TS}. Here T_{n-1TS} is generated by the trusted server in a previous response. Accordingly, the Request(n) comprises a function of at least a portion of a previous response. The device generates a request message (107), Request(n) (see expression below), where PT (Plain Text) is that portion of the client-side user's message content to be delivered in bulk-encrypted form. A 24-byte triple-DES key (MsgK) is generated. PT is triple-DES encrypted with MsgK. The concatenation of Tₙ and MsgK is then OAEP-padded and RSA-encrypted with the trusted server's (TS) public key. A CBC (cipher-block-chaining) MAC is generated over the Protocol Header concatenated with the “data” [{Tₙ,MsgK}TSPubK, {PT}MsgK]. The MAC is generated using T_{n-1TS} .XOR. Tₙ₋₁. Note that T_{n-1TS} .XOR. Tₙ₋₁ is 16 bytes, so a double key is used to run the triple-DES algorithm when calculating the MAC. The Protocol Header and Tₙ₋₁ are prepended to the MAC. The data is appended after the MAC.

In this request, Tₙ and MsgK are freshly generated values.

Therefore, Tₙ and the message key MsgK are encrypted using the public key of the server for the purpose of transport to the server. Since the client device generates a new message key for every request, no memory is required to store the message key.

Request(n)=Protocol Header, Tₙ₋₁,

MAC(Protocol Header, data)T_{n-1TS}.XOR.Tₙ₋₁, data,

where data={Tₙ,MsgK}TSPubK, {PT}MsgK.

Prior to transmitting Request(n), the device goes into the following persistent memory state (109):

Tₙ₋₁, T_{n-1TS}, Tₙ. The Request(n) is then transmitted (111), and a Response(n) is transmitted from the server to the device(113). The server-side flow is discussed below.

Upon receiving a Response(n), the device fully processes the response since MsgK, having been generated randomly (or pseudo-randomly) is not the ALL NULLS vector which would indicate that the device is in resynchronization mode (discussed below) rather than in basic-flow mode. At the conclusion of satisfactory verification (115) of Response(n) from the trusted server, the device goes into the following persistent memory state (117):

Tₙ, T_{nTS}, Blank.

Device-Side Flow—Re-Establishing Cryptosynchronization

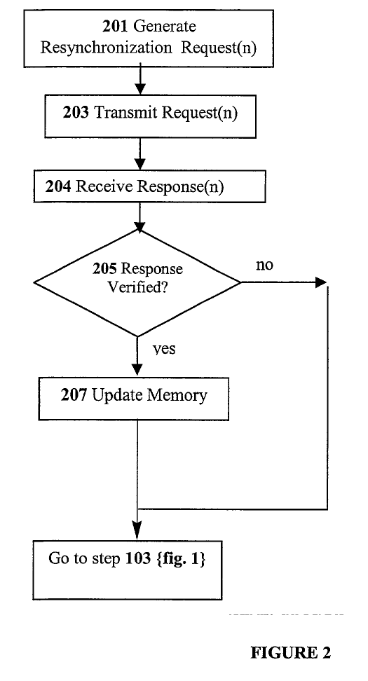

Reference is now made to FIG. 2. Suppose, for example, the client device has timed out or the client-side processor has crashed, so that the device is in persistent memory state Tₙ₋₁, T_{n-1TS}, Tₙ and is not awaiting Response(n). When operation of the client device resumes, it generates a message key that indicates that the device is in resynchronization mode. Preferably, the client device generates a NULL MsgK and transmits a special resynchronization request (201) using the NULL MsgK. No PT is present:

Request(n)=Protocol Header, Tₙ₋₁,

MAC(Protocol Header, data)T_{n-1TS}.XOR.Tₙ₋₁, data,

where data={Tₙ, MsgK}TSPubK, and where the encryption key MsgK=All NULLs.

The device knows that it is in cryptosynchronization mode and not in normal transmit (basic-flow) mode: The fact that in volatile memory MsgK=All NULLs informs the client device to disregard any {PT}MsgK′ field when verifying a received Response(n). The response may include such an encrypted-data field in the event that it is actually a stored response first generated in response to a basic-flow—rather than a resynchronization—request. Since the MAC in the response, in this case, is computed over ciphertext {PT}MsgK′ rather than plaintext PT, the device does not need to do the decryption in order to verify the MAC.

At the conclusion of satisfactory verification of Response(n) from the trusted server (205), the device updates memory to the following persistent memory state (207):

Tₙ, T_{nTS}, Blank

Server-Side Basic Flow

Prior to first receiving a Request(n) from the device for a given value of n, the trusted server database values for that device are:

Tₙ₋₂, Tₙ₋₁, T_{n-1TS}, Response(n-1)

Upon satisfactory verification of Request(n), the trusted server generates T_{nTS} and Response(n), and its database values are:

Tₙ₋₁, Tₙ, T_{nTS}, Response(n)

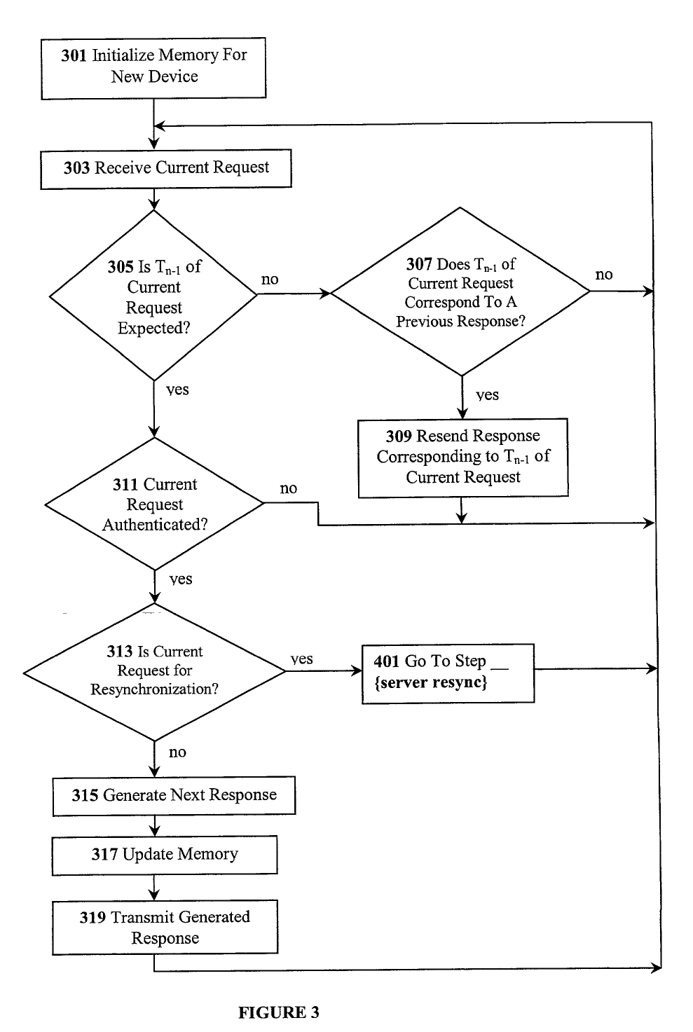

Reference is now made to FIG. 3. Upon receipt of the request from the client device (303), the trusted server establishes which messaging protocol to use based on the Protocol Header's version field. The trusted server establishes the identity of the client device based on Tₙ₋₁ and retrieves T_{n-1TS} from the database entry using Tₙ₋₁ (305). The server validates the MAC using T_{n-1TS} .XOR. Tₙ₋₁. Using its private key, the trusted server decrypts and OAEP-decodes {Tn,MsgK}TSPubK, and saves Tₙ. The recovered value of MsgK is used to decrypt {PT}MsgK to recover PT. The trusted server then processes PT accordingly.

In one embodiment of the invention, if there is no current one-time password entry in the server database that corresponds to the incoming value Tₙ₋₁, the server attempts to match the incoming value against a Tₓ corresponding to a previously generated response (307). If the look-up is successful, the server retransmits the response corresponding to Tₙ₋₁ of the incoming request (309). More specifically, if the trusted server's values for a given device are currently Tₙ₋₁, Tₙ, T_{nTS}, Response(n), then Tₙ₋₁ is not used by the trusted server to freshly process the request. Instead, the corresponding Response(n) is used to re-establish (crypto)synchronization between the trusted server and the device, in the event that the trusted server has updated its database entry for the device, but the device has not updated its state.

If Tₙ₋₁ in the incoming request is expected (in that it matches a current one-time password) and the request is authenticated, then the server verifies that the request is not a request for resynchronization (313). If resynchronization is needed, a resynchronization response is generated as is further discussed below. If resynchronization is not needed, the trusted server generates a new 2-key triple-DES key Y, and lets T_{nTS}=Y .XOR. Tₙ, and generates a Response(n) (315) with its own PT and a freshly generated MsgK′. The response message is generated in the same format as the request message except that the MAC is calculated using Tₙ.XOR.T_{n-1TS} and the new T_{nTS} appears as an argument encrypted under the device's public key DevicePubK:

Response(n)=Protocol Header, Tₙ₋₁,

MAC(Protocol Header, data)Tₙ.XOR.T_{n-1TS}, data,

where data={T_{nTS},MsgK′}DevicePubK, {PT}MsgK′.

The generated Response(n) includes a confirming function of the next one-time password Tₙ via the key used to calculate the response MAC.

In this response, T_{nTS} and MsgK′ are freshly generated values, wherein the message key that is returned (MsgK′) is different from the message key generated by the device (MsgK).

Neither request message key MsgK nor response message key MsgK′ is saved into the database. After the HSM decrypts the request and generates a response, timely access to the database values Tₙ and T_{n-1TS} (previous) would enable a substitution of the response with a different one that would be acceptable to a compliant client platform. But if the protocol is modified so that the client device (or the inclusive client platform) expects MsgK .XOR. MsgK′ (instead of MsgK′) to be sent encrypted using the client platform's public key, then a substitution of response would not be accepted since neither MsgK, nor the MsgK′ as generated by the HSM, should leave the HSM. The client device still does not need to store its MsgK in non-volatile memory, since it only reestablishes cryptosynchronization and thus ignores any bulk-encrypted content of the response message if the first response is not received when expected.

In persistent memory, the trusted server previously had (in some form of accessible storage): Tₙ₋₂, Response(n-1), Tₙ₋₁, T_{n-1TS}. This is now replaced with: Tₙ₋₁, Response(n), Tₙ, T_{nTS} (317). Knowledge of T_{n-1TS} is no longer required once Response(n) has been generated and saved.

The trusted server sends Response(n) to the client device (319). Upon receipt of the message, the device verifies the Protocol Header's version and ignores Tₙ₋₁. The MAC is verified using Tₙ.XOR.T_{n-1TS}. Using its private key, the client device decrypts and OAEP decodes {T_{nTS},MsgK′}DevicePubK. The device uses MsgK′ to decrypt PT. The device processes the PT accordingly.

In persistent or non-volatile memory, the device previously had: Tₙ₋₁, T_{n-1TS}, Tₙ. This is now replaced with: Tₙ, T_{nTS}, Blank.

Server-Side Flow—Re-Establishing Cryptosynchronization

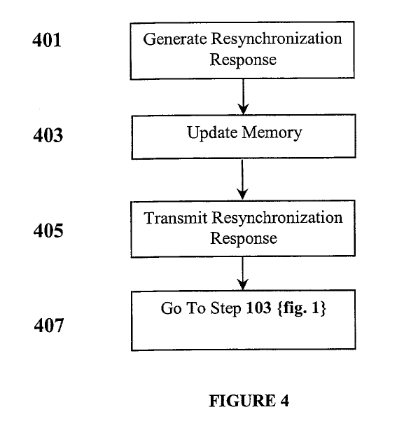

Referring now to FIG. 4, the server decrypts and processes the message. If the trusted server's database values for that device are Tₙ₋₂, Tₙ₋₁, T_{n-1TS}, Response(n-1) when it receives this Request(n), it processes the request and generates T_{nTS} and Response(n) (401) using a message key that indicates that the device is in resynchronization mode. Preferably, the client device generates a NULL MsgK′. No PT is present. The server then transmits Response(n) (405):

Response(n)=Protocol Header, Tₙ₋₁,

MAC(Protocol Header, data)Tₙ.XOR.T_{n-1TS}, data,

where data={T_{nTS}, MsgK′}DevicePubK, and where the encryption key MsgK′=All NULLs

Its database values are updated to include Tₙ₋₁, Tₙ, T_{nTS}, and Response(n) (403).

If the device server's database values for that device are Tₙ₋₁, Tₙ, T_{nTS}, Response(n), for some Response(n), when it receives this Request(n), it (re)transmits Response(n). In this case Tₙ₋₁ within the received Request(n) is used to access the database entry, i.e., the previously transmitted and stored value of Response(n). If the request had been “fresh,” Tₙ would have been used to access the database entry, i.e. T_{nTS}, and the device public key DevicePubK.

The client device processes the response message and updates its persistent memory as discussed above in connection with FIG. 1 and FIG. 2.

If the possibility of state loss at a server is of concern, an extension of the invention can be deployed to take advantage of availability of infrequently accessed fail-safe backup. For example, in the case of exception processing with respect to “Duress mode” (as exemplified below), the server may be able to access a remote backup service or facility which acknowledges uncorrupted receipt of backup-request messages. In the event of detected or suspected state loss at the server, the server would retrieve a copy of the data that it had deposited with the backup facility. In an embodiment of this state-recoverability method: When the device and server agree on initial values To and TOTS as part of registration or other initialization, they also agree on an initial pair of Duress values, Duress-T₀ and Duress-T_{0TS}. If resynchronization as described thus far, fails to achieve the desired effect (of regaining or reestablishing (crypto-)synchronization) after a prescribed number of attempts or a prescribed elapse of time (or other metric) as may be tracked by the device (or device user) utilizing known methods, an exception processing version of resynchronization may be employed. It is understood that the term device-side resynchronization comprises the exception processing or duress mode version of device-side processing. It is understood that the term server-side resynchronization comprises the exception processing or duress mode version of server-side processing. A duress request message is considered to be (one type of) a request message. A duress response message is considered to be (one type of) a response message. The device generates and transmits a Duress request message. This follows the format of a standard request message, as does the resulting Duress response message relative to a standard response message, with certain qualifications. Namely, the current Duress-T values rather than the current (standard) T values are used within the Duress Request and Duress Response; the newly generated T values in the Duress Request and Duress Response, respectively, are used to reset to a new “just-registered” starting point and hence are designated here as T₀ and T_{0TS}, respectively (but are unrelated to the original T₀ and T_{0TS} values). The PT field of Duress Request(m) includes (at least) Duress-Tₘ, and the PT field of Duress Response(m) includes (at least) Duress-T_{mTS}.

Duress Request(m)=Protocol Header, Duress-Tₘ₋₁,

MAC(Protocol Header, data)Duress-T_{m-1TS}.XOR.Duress-Tₘ₋₁, data,

where data={T₀,MsgK}TSPubK,{Duress-Tₘ}MsgK.

Duress Response(m)=Protocol Header, Duress-Tₘ₋₁,

MAC(Protocol Header, data)Duress-Tₘ.XOR.Duress-T_{m-1TS}, data,

where data={T_{0TS},MsgK′}DevicePubK, {Duress-TmTS}MSgK′.

Unlike standard request processing by the device, a retry of a failed Duress Request message is an exact copy of the previous (failed) attempt. Unlike standard server database updating, when the server locally updates from

Duress-Tₘ₋₂, Duress-Tₘ₋₁, Duress-T_{m-1TS}, Duress Response(m-1), to

Duress-Tₘ₋₁, Duress-Tₘ, Duress-T_{mTS}, Duress Response(m),

this change is also backed up using fail-safe communications or other ultra-reliable means.

An alternative embodiment of the basic invention would combine the authentication and public key encryption phases, thus eliminating the use of the MAC. This is a less-phased approach in that a hit on the server database indicating that an incoming request is current would precipitate RSA-OAEP processing of the request message at the server prior to verifying the authenticity of the request-message data. In the MAC-based embodiment, failure of the MAC to verify precipitates an abort to message processing at the server. An embodiment of the request and response messages in the MAC-less approach could employ a one-way hash function H, such as SHA-1:

Request(n)=Protocol Header, Tₙ₋₁,

{T_{n-1TS}, Tₙ, H(Protocol Header, PT), MsgK}TSPubK, {PT}MsgK; and

Response(n)=Protocol Header, Tₙ₋₁,

{T_{nTS}, Tₙ, H(Protocol Header, PT), MsgK′}DevicePubK, {PT}MsgK′.

It should be understood that various changes and modifications to the embodiments described herein will be apparent to those skilled in the art. Such changes and modifications can be made without departing from the spirit and scope of this invention and without diminishing its attendant advantages. It is therefore intended that such changes and modifications be covered in the appended claims.

I claim:

1. A method for enhancing trust in communications between a client device and a trusted server, comprising:
(a) generating a one-time password for use in communication from the device to the server;
(b) generating at least one one-time request-authentication datum comprising a function of at least a portion of a previous response from the server to a previous request from the device; and
(c) generating at least one one-time response-authentication datum comprising a function of at least a portion of at least one one-time password.

2. The method of claim 1, wherein said one-time request-authentication datum comprises a function of an encryption key.

3. The method of claim 1, wherein said one-time response-authentication datum comprises a function of an encryption key.

4. A method for enhancing trust in communicating a data request from a client device, comprising:
(a) generating a one-time password; and
(b) generating at least one one-time request-authentication datum comprising a function of at least a portion of a previous response from a trusted server to a previous request from the device.

5. The method of claim 4, wherein said one-time request-authentication datum comprises a function of an encryption key.

6. A method for enhancing trust in communicating a response from a request from a client device to a trusted server, comprising:
(a) receiving a request comprising a function of at least a portion of at least one one-time password shared between the device and said server; and
(b) generating at least one one-time response-authentication datum comprising a function of at least a portion of at least one one-time password.

7. The method of claim 6, wherein said one-time response-authentication datum comprises a function of an encryption key.

8. The method of claim 6, wherein said request comprises an encrypted secret datum, wherein said server decrypts said encrypted secret datum to recover said secret datum.

9. The method of claim 8, wherein a subsequent request comprises a function of at least a portion of at least one one-time password comprising at least a portion of at least one secret datum.

10. The method of claim 6, wherein the one-time password comprised within the request is used by the server to locate an entry in its database corresponding to the particular client device.

11. A method for resynchronizing communication between a client device and a trusted server, comprising:
(a) supplying a one-time password for use in communication from the device to the server;
(b) supplying at least one one-time request-authentication datum comprising a function of at least a portion of a previous response from the server to a previous request from the device; and
(c) supplying at least one one-time response-authentication datum comprising a function of at least a portion of at least one one-time password.

12. A method for enhancing trust in transmission of a resynchronization request from a client device, comprising:
(a) supplying a one-time password; and
(b) supplying at least one one-time request authentication datum comprising a function of at least a portion of a previous response from a trusted server to a request from the device.

13. The method of claim 12, wherein said resynchronization request comprises an encrypted resynchronization datum that replaces a previous resynchronization datum.

14. A method for enhancing trust in transmission of a resynchronization response from a trusted server, comprising:
(a) receiving a request comprising a one-time password associated with a client device; and
(b) supplying at least one one-time response-authentication datum comprising a function of at least a portion of at least one one-time password.

15. The method of claim 14, wherein said resynchronization response comprises an encrypted resynchronization datum that replaces a previous resynchronization datum.

16. A system for enhancing trust in communications between a client device and a trusted server, comprising:
(a) means for establishing a network connection between the client device and the server; and
(b) means for conducting communications of data with the client device over the network connection,
wherein said communications between the device and the server are conducted in accordance with a method comprising:
(i) generating a one-time password for use in communication from the device to the server;
(ii) generating at least one one-time request-authentication datum comprising a function of at least a portion of a previous response from the server to a previous request from the device; and
(iii) generating at least one one-time response-authentication datum comprising a function of at least a portion of at least one one-time password.

17. The system of claim 16, further comprising
(a) an encryption algorithm, and
(b) means for downloading said encryption algorithm to the client computer over said network connection,
wherein said means for conducting communications of data with the client computer over the network connection is in accordance with said encryption algorithm and wherein said communications between the device and the server are conducted on an encrypted basis.

18. The system of claim 16, wherein said one-time request-authentication datum comprises a function of an encryption key.

19. The system of claim 16, wherein said one-time response-authentication datum comprises a function of an encryption key.

20. A system for enhancing trust in communicating a data request from a client device, comprising:
(a) means for establishing a network connection between the client device and a trusted server; and
(b) means for conducting communications of data with the client device over the network connection,
wherein said communications between the device and the server are conducted in accordance with a method comprising:
(i) generating a one-time password; and
(ii) generating at least one one-time request-authentication datum comprising a function of at least a portion of a previous response from a trusted server to a previous request from the device.

21. The system of claim 20, further comprising
(a) an encryption algorithm, and
(b) means for downloading said encryption algorithm to the client computer over said network connection,
wherein said means for conducting communications of data with the client computer over the network connection is in accordance with said encryption algorithm and wherein said communications between the device and the server are conducted on an encrypted basis.

22. The system of claim 20, wherein said one-time request-authentication datum comprises a function of an encryption key.

23. A system for enhancing trust in communicating a response from a request from a client device to a trusted server, comprising:
(a) means for establishing a network connection between the client device and the server; and
(b) means for conducting communications of data with the client device over the network connection,
wherein said communications between the device and the server are conducted in accordance with a method comprising:
(i) receiving a request comprising a function of at least a portion of at least one one-time password shared between the device and said server; and
(ii) generating at least one one-time response-authentication datum comprising a function of at least a portion of at least one one-time password.

24. The system of claim 23, further comprising
(a) an encryption algorithm, and
(b) means for downloading said encryption algorithm to the client computer over said network connection,
wherein said means for conducting communications of data with the client computer over the network connection is in accordance with said encryption algorithm and wherein said communications between the device and the server are conducted on an encrypted basis.

25. The system of claim 23, wherein said one-time response-authentication datum comprises a function of an encryption key.

26. The system of claim 23, wherein said request comprises an encrypted secret datum, wherein said server decrypts said encrypted secret datum to recover said secret datum.

27. The system of claim 26, wherein a subsequent request comprises a function of at least a portion of at least one one-time password comprising at least a portion of at least one secret datum.

28. The method of claim 23, wherein the one-time password comprised within the request is used by the server to locate an entry in its database corresponding to the particular client device.

29. A system for resynchronizing communication between a client device and a trusted server, comprising:
(a) means for establishing a network connection between the client device and the server; and
(b) means for conducting communications of data with the client device over the network connection,
wherein said communications between the device and the server are conducted in accordance with a method comprising:
(i) supplying a one-time password for use in communication from the device to the server;
(ii) supplying at least one one-time request-authentication datum comprising a function of at least a portion of a previous response from the server to a previous request from the device; and
(iii) supplying at least one one-time response-authentication datum comprising a function of at least a portion of at least one one-time password.

30. The system of claim 29, further comprising
(a) an encryption algorithm, and
(b) means for downloading said encryption algorithm to the client computer over said network connection,
wherein said means for conducting communications of data with the client computer over the network connection is in accordance with said encryption algorithm and wherein said communications between the device and the server are conducted on an encrypted basis.

31. A system for enhancing trust in transmission of a resynchronization request from a client device, comprising:
(a) means for establishing a network connection between the client device and a trusted server; and
(b) means for conducting communications of data with the client device over the network connection,
wherein said communications between the device and the server are conducted in accordance with a method comprising:
(i) supplying a one-time password; and
(ii) supplying at least one one-time request authentication datum comprising a function of at least a portion of a previous response from the server to a request from the device.

32. The system of claim 31, further comprising
(a) an encryption algorithm, and
(b) means for downloading said encryption algorithm to the client computer over said network connection,
wherein said means for conducting communications of data with the client computer over the network connection is in accordance with said encryption algorithm and wherein said communications between the device and the server are conducted on an encrypted basis.

33. The system of claim 31, wherein said resynchronization request comprises an encrypted resynchronization datum that replaces a previous resynchronization datum.

34. A system for enhancing trust in transmission of a resynchronization response from a trusted server, comprising:
(a) means for establishing a network connection between a client device and the server; and
(b) means for conducting communications of data with the client device over the network connection,
wherein said communications between the device and the server are conducted in accordance with a method comprising:
(i) receiving a request comprising a one-time password associated with a client device; and
(ii) supplying at least one one-time response-authentication datum comprising a function of at least a portion of at least one one-time password.

35. The system of claim 34, further comprising
(a) an encryption algorithm, and
(b) means for downloading said encryption algorithm to the client computer over said network connection,
wherein said means for conducting communications of data with the client computer over the network connection is in accordance with said encryption algorithm and wherein said communications between the device and the server are conducted on an encrypted basis.

36. The system of claim 34, wherein said resynchronization response comprises an encrypted resynchronization datum that replaces a previous resynchronization datum.
